(19) United States
(12) Patent Application Publication
(10) Pub. No.: US 2009/0010251 A1
(43) Pub. Date: Jan. 8, 2009

(54) Simplifying DSL Deployment via Analog/DSL Combination Solution

(75) Inventors: William R. Bullman, Bethlehem, PA (US); Anthony J. Grewe, Fogelsville, PA (US); Steven E. Strauss, Orefield, PA (US)

Correspondence Address: MENDELSOHN & ASSOCIATES, P.C., 1500 JOHN F. KENNEDY BLVD., SUITE 405, PHILADELPHIA, PA, 19102, US

(73) Assignee: AGERE SYSTEMS INC., Allentown, PA (US)

(21) Appl. No.: 12/207,049

(22) Filed: Sep. 9, 2008

Related U.S. Application Data
(63) Continuation of application No. 09/665,594, filed on Sep. 19, 2000.

(51) Int. Cl. H04L 12/66

(52) U.S. Cl. 370/352

(57) ABSTRACT

A method using a combination analog/DSL modem for deploying DSL services is disclosed. A combination analog/DSL modem is utilized at the subscriber premises. A telephone line is tested using the analog portion of the modem. In combination with information provided by the subscriber and records, suitability of the service line for DSL services may be accurately determined. DSL service is then ordered by the subscriber. Preferably, DSL services are deployed on top of the existing analog voice service line allowing service turn-on within a short period of time. The subscriber can have the ability to access a network using the DSL portion of the combination modem. If during modem testing, it is determined that the telephone line would not support DSL service, the subscriber would be informed that DSL service is currently not available for them. However, the subscriber could continue to use the analog portion of the combination modem.

### CROSS-REFERENCE TO RELATED APPLICATIONS

This is a continuation of co-pending application Ser. No. 09/665,594, filed on Sep. 19, 2000 as attorney docket no. Bullman 7-26-6, the teachings of which are incorporated herein by reference.

### BACKGROUND OF THE INVENTION

1. Field of the Invention

This invention relates generally to deployment and use of digital data services via a telephone line. More particularly, it relates to the use an analog/DSL modem to automatically and/or remotely determine a capability of potential subscribers' telephone line to support DSL services in addition to analog voice services.

2. Background of Related Art

The growing demand for access to networked resources (such as via the Internet) has led to increasing interest in higher speed broadband connections. A typical way to access network resources is via dial-up connections using analog dial modems.

The advent of digital subscriber line (“DSL”) services has enabled a promising way to access network resources. DSL is a copper loop transmission technology which utilizes the existing voice telephony copper (i.e., telephone line), but delivers a higher information rate than analog dial-up technology.

FIG. 8 shows the frequency spectrums of traditional analog voice and asymmetric DSL.

Voice telephony and current analog dial-up modems limit their transmission spectrums to a 0 to 3.4 kHz range for a voice channel 801 as shown in FIG. 8. The highest information rate currently achievable within a 3.4 kHz spectrum is 56 kbps.

DSL achieves a higher information rate by using a broader range of frequencies than an analog voice channel 801. For example, asymmetric DSL (“ADSL) utilizes frequencies up to 1.2 MHz for faster data services versus using an analog voice channel. As shown in FIG. 8, ADSL technologies utilize a separate upstream channel 802 and downstream channel 803. Today, ADSL transmits an asymmetric data stream at up to 1 Mbps upstream (to the network) and up to 7 Mbps downstream (to the subscriber).

Transmission of data over a broader range of frequencies using DSL technologies such as ADSL requires complementary DSL devices at each end of a copper loop.

FIG. 6 shows a general topology for conventional DSL services.

In particular, FIG. 6 shows a typical subscriber location 601 with DSL service and plain old telephone (“POT”) service. A subscriber's personal computer 602 is connected to a DSL modem 603. The DSL modem 603 is connected via inside wiring 604 to a network interface device (“NID”) 607. At the NID, the inside wiring 604 is connected to a DSL service line 608a. The DSL service line 608a is routed to a serving central office 609. The DSL service line is connected via a main distribution frame (“MDF”) 613 to a complementary DSL device 612 (such as a DSL access multiplexer or “DSLAM”) within the central office 609. A high speed connection 614 (such as a T1, DS3, etc.) connects the complementary DSL device 612 to a data network (such as the Internet).

As shown in FIG. 6, DSL service is typically provided using a separate service line from a subscriber's traditional POT service. A subscriber's telephone 605 is connected via inside wiring 606 to the NID 607. Of note, a subscriber's POT service line 608b is separate from the dedicated DSL service line 608a. At the NID, a subscriber's POT service is routed via the POT service line 608b to the service central office 609 into the MDF 613. The subscriber's POT service is then routed to the public switched telephone network (“PSTN”) 611.

One problem with DSL services is that they are difficult to deploy because a separate service line may be required. Moreover, there are many inefficiencies in the current process which have slowed the deployment of DSL.

It is desirable for DSL network service providers to deploy service quickly when requested by their subscribers. Furthermore, quick deployment of DSL service can reduce operations costs, increase revenue, improve customer satisfaction and speed up deployment.

Today, DSL deployment requires four steps: (1) prequalification; (2) copper provisioning; (3) turning on the service; and (4) post installation issues.

FIG. 7 shows a conventional process of deploying DSL.

In particular, in step 701 a subscriber submits an initial request to a network service provider for DSL service.

In step 702, a network service provider will conduct a prequalification of a subscriber.

Prequalification attempts to determine whether a subscriber location can support DSL service. However, DSL has several limitations which prevent deployment under certain circumstances. For instance, several factors which might prohibit a subscriber's location from supporting DSL services include:
Distance from the central office is too far (e.g. greater than 12,500 feet for ADSL).
Subscriber location is served by a remote terminal.
Bridge taps are present in the copper pair.
Load coils are present in the copper pair.

Typically, a network service provider will estimate a subscriber's distance from their serving central office based on an address and phone number. Also, a network service provider will check written records to determine if any limiting factors are present (e.g. remote terminal, bridge taps, load coils, etc.). If the distance is estimated to be too far, or if written records indicate the presence of any limiting factors, then a network service provider will often not even attempt to deploy DSL service to that subscriber because of cost concerns.

In step 703, if a subscriber location passes prequalification, a network service provider then provisions a connection from the subscriber's location 601 to the central office 609 and finally to the service provider's complementary DSL device 612 via the MDF 613. This process is known as copper provisioning and requires coordination between the network service provider and the local exchange carrier (“LEC”).

In steps 704 and 705, if copper provisioning is successful, the next step is to turn on DSL service over the delivered connection 608a (i.e., telephone line). Turning on DSL service involves terminating the connection at the appropriate point on a service provider's complementary DSL device 612 and installing a DSL modem 603 and any necessary inside wiring 604 at the subscriber's location 601. This is done by the network service provider from whom the subscriber ordered DSL service.

Ideally, when turning on service a technician arrives at the subscriber's location 601, installs the inside wiring 604, installs the DSL modem 603, tests the DSL service and leaves the premises within ninety minutes.

Unfortunately, there are many inefficiencies with the current process during each of the steps 701-706.

During prequalification, the written records available to a network service provider are often inaccurate. In addition, the written records often cover only the copper pair used for a DSL service line 608a from the central office 609 to the NID 607. Written records often do not provide complete information as to the state of inside wiring 604 within the subscriber location 601. Inside wiring 604 may be a myriad of wire types, gauges, and of any configuration which can impact the performance of DSL. As a result, network service providers are often forced to dispatch technicians to a subscriber's location and install new inside wiring.

During copper provisioning, coordination with the LEC often takes a substantial amount of time (e.g. several weeks) to provision a connection from the subscriber's location 601 to the central office 609. Provisioning a connection from the MDF 613 to the service provider's complementary DSL device 612 may also take a substantial amount of time.

In addition, there are often errors which may not be discovered until later. For example, a misconnection to a wrong location other than the subscriber location 601, or a misconnection at the MDF 613 or a misconnection at the service provider's complementary DSL device 612 may be discovered late in the process.

Moreover, when turning on the service, the technician may discover misconnections at the service provider's complementary DSL device 612 or at the subscriber's location 601. For instance, the technician may discover load coils and/or bridge taps during testing which were not identified in the written records. Also, the distance from the central office 609 to the subscriber's location 601 may have been inaccurately estimated causing a need to down-grade DSL service from that which was ordered initially. Any of these problems can lead to lost revenue to the network service provider as well as subscriber dissatisfaction.

Post installation issues 706 can also be difficult. For example, troubleshooting DSL service can be a lengthy and difficult process. When a problem with DSL service occurs, a network service provider may need to dispatch a technician. During troubleshooting, a technician must usually travel to the subscriber location 601 to check for a failure in the DSL modem 603, in the subscriber's PC 602, or in the inside wiring 604. The technician may also need to travel to the central office 609 to check the service provider's complementary DSL device 612 or verify the connection from the MDF 613. If the equipment is in order, the technician may then have to use DSL test equipment which places tones on the DSL service line 608a to detect any problems. This process is labor intensive and can take a substantial amount of time.

Accordingly, as described above, DSL deployment is a labor intensive process with many inefficiencies.

Thus, there is need for an improved process and apparatus for deploying DSL in a way and at a cost that meets the expectations of both the consumer as well as the DSL network service provider.

### SUMMARY OF THE INVENTION

In accordance with the principles of the present invention, a method for deploying digital subscriber line (DSL) service via a combination analog/DSL modem comprises logging a subscriber into a network site via an analog modem portion of a combination analog/DSL modem; determining a suitability of a service line used by the subscriber for supporting DSL service via the combination analog/DSL modem; and approving installation of DSL service on the service line when the suitability is determined to support DSL service.

In accordance with another aspect of the present invention, a computer program product for deploying DSL services via a combination analog/DSL modem comprises a computer usable medium having computer readable program code, the computer readable program code including: program code for logging into a network site via an analog modem portion of a combination analog/DSL modem; program code for determining a suitability of a service line for DSL services via the combination analog/DSL modem; and program code for installing DSL services when said service line is determined to be suitable to support DSL services.

In accordance with another aspect of the present invention, a combination analog/DSL modem comprises an analog modem module; a DSL modem module; a parameter test module adapted to measure at least one parameter of a service line via the analog modem module; and a parameter reference module adapted to correlate the measurement by the parameter test module to a suitability for supporting services via the DSL modem module.

### BRIEF DESCRIPTION OF THE DRAWINGS

Features and advantages of the present invention will become apparent to those skilled in the art from the following description with reference to the drawings, in which:

FIG. 1 shows an exemplary topology for DSL services in accordance with the principles of the present invention.

FIG. 2 shows a more detailed depiction of a combination analog/DSL modem.

FIG. 3 shows a more detailed view of a serving central office.

FIG. 4 shows an exemplary process for deploying DSL, in accordance with the principles of the present invention.

FIG. 5 shows how post installation issues such as troubleshooting may be handled as part of deploying DSL service, in accordance with the principles of the present invention.

FIG. 6 shows the bandwidth of a traditional analog voice channel and the bandwidth of the upstream and downstream channels of conventional asymmetric DSL technology.

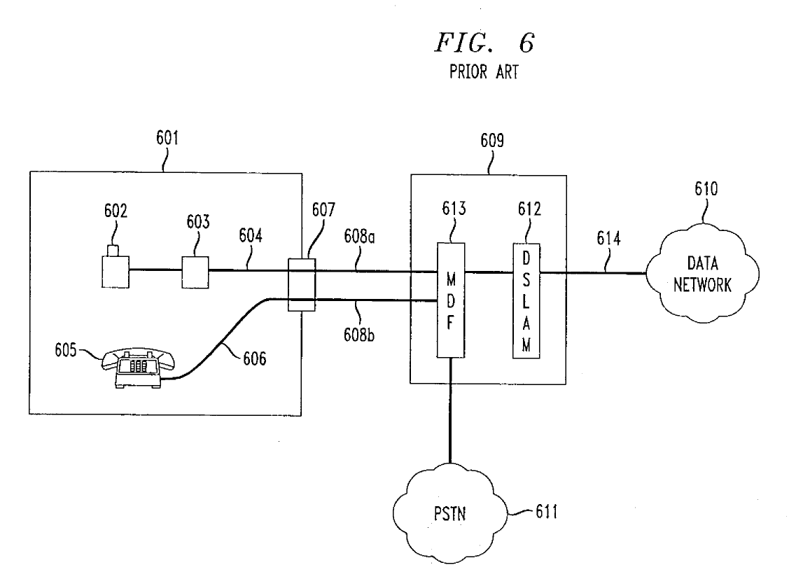

FIG. 7 shows a general topology for conventional DSL services.

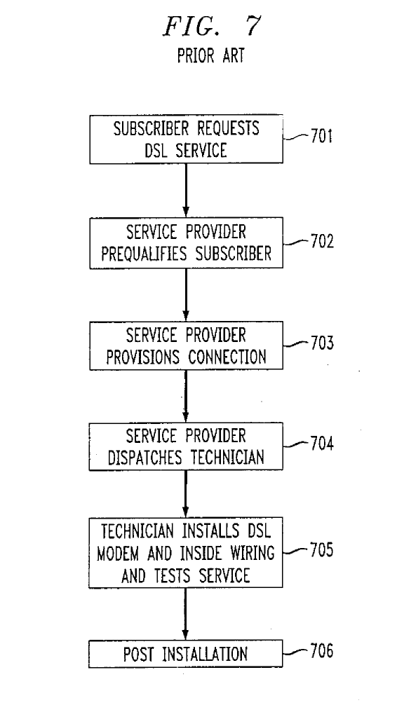

FIG. 8 shows a conventional process for deploying DSL services.

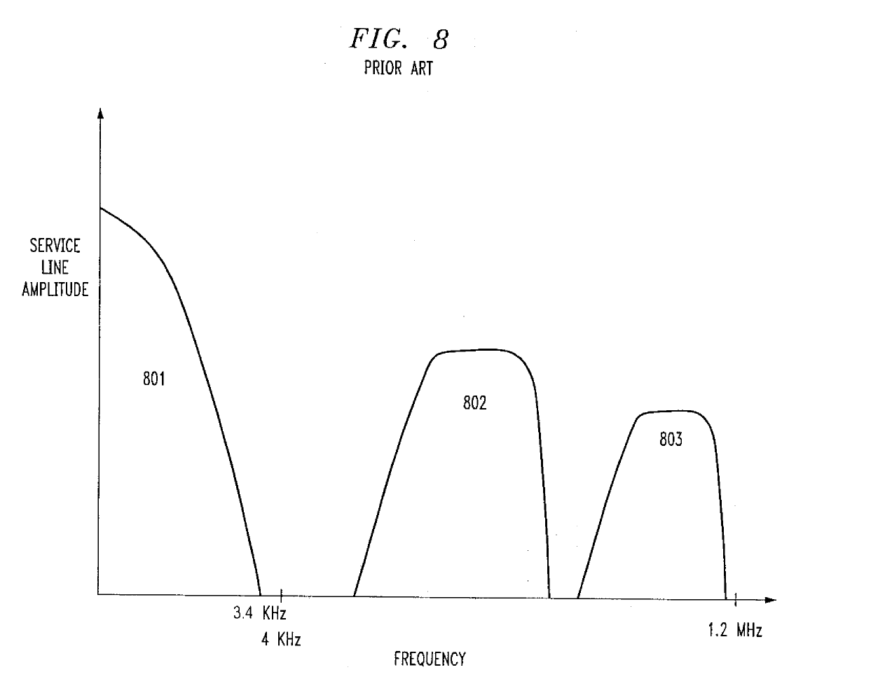

### DETAILED DESCRIPTION OF ILLUSTRATIVE EMBODIMENTS

The present invention provides an automated process for deploying DSL services using a combination analog/DSL modem.

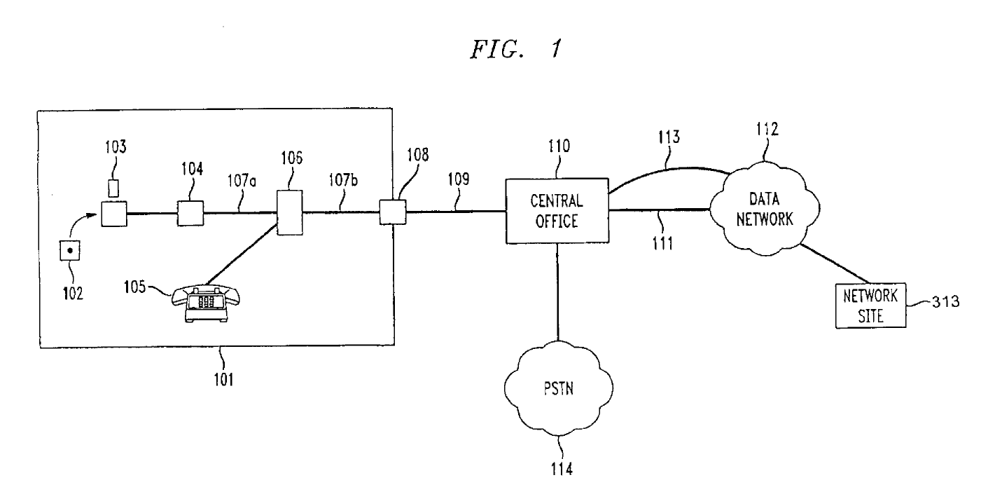

FIG. 1 shows an exemplary topology for DSL services in accordance with the principles of the present invention.

In particular, as shown in FIG. 1, a subscriber location 101 includes subscriber equipment 103 (e.g. a personal computer), a combination analog/DSL modem 104, a traditional telephone 105, and a splitter 106.

The subscriber's equipment 103 is connected to a combination analog/DSL modem 104. The combination analog/DSL modem 104 is connected to a splitter 106 via inside wiring 107a. The splitter 106 allows the copper service line 109 to be used for simultaneous DSL transmission and transmission using the analog voice channel. The splitter 106 is connected to a NID 108 via inside wiring 107b. Analog voice traffic from a telephone 105 is also routed through the splitter 106 to the NID 108.

From the NID 108, a copper service line 109 carries the DSL and analog voice traffic to a serving central office 110. DSL traffic is routed to a data network 112 (e.g. the Internet). A network site 113 is accessible via the data network 112. Analog voice traffic is routed to the PSTN 114.

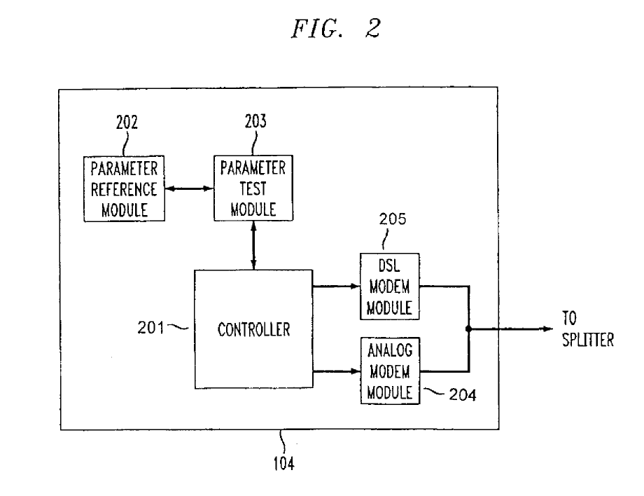

FIG. 2 is a more detailed depiction of the combination analog/DSL modem shown in FIG. 1.

In particular, a controller 201, a parameter test module 203, parameter reference module 202, DSL modem module 205, and analog modem module 204 are shown within a combination analog/DSL modem 109.

The controller 201 controls the operations of the combination analog/DSL modem. The controller controls the passing of information between the parameter test module 203 and DSL modem module 205, and analog modem module 204. The controller 201 also allows the subscriber to select data transmission using the DSL modem module 205 or analog modem module 204.

The parameter test module 203 in conjunction with the parameter reference module 202 allows for testing of the wiring between the combination analog/DSL modem 104 and the serving central office 110. The parameter test module 203 uses algorithms and DSP code known by those of ordinary skill in the art to measure several parameters. Suitable parameters measured may include signal amplitude, return echo, tip voltage, ring voltage, capacitance and /or impedance to determine, e.g., line length, noise, presence of load coils, and presence of bridge taps.

Although several parameters are disclosed, other parameters which may affect suitability of supporting DSL service may be implemented within the principles of the present invention.

The parameter reference module 202 correlates the parameters measured by the parameter test module 203 to a suitability of the copper service line 109 for supporting DSL service. For example, line length may be correlated to the measured capacitance, e.g., by using 0.078-0.086 μF/mile, in determining whether the service line 109 is too long (e.g. greater than 12,500 ft).

Although a correlation of capacitance to line length is disclosed, other correlations to determine a suitability for a copper service line 109 may be implemented within the principles of the present invention.

The analog modem 204 allows for data transmission using an analog dial-up session known by those of ordinary skill in the art. The analog modem 204 preferably allows for data transmission up to 56 kbps using an analog voice channel.

Although a 56 kbps analog modem is shown, other analog modems which use an analog voice channel may be implemented within the principles of the present invention.

The DSL modem 205 allows for data transmission using DSL technology. The DSL modem 205 preferably uses ADSL technology known by those of ordinary skill in the art.

Although ADSL technology is disclosed, other DSL technologies which allow for simultaneous DSL transmission and analog voice channel transmission over the same service line may be implemented within the principles of the present invention.

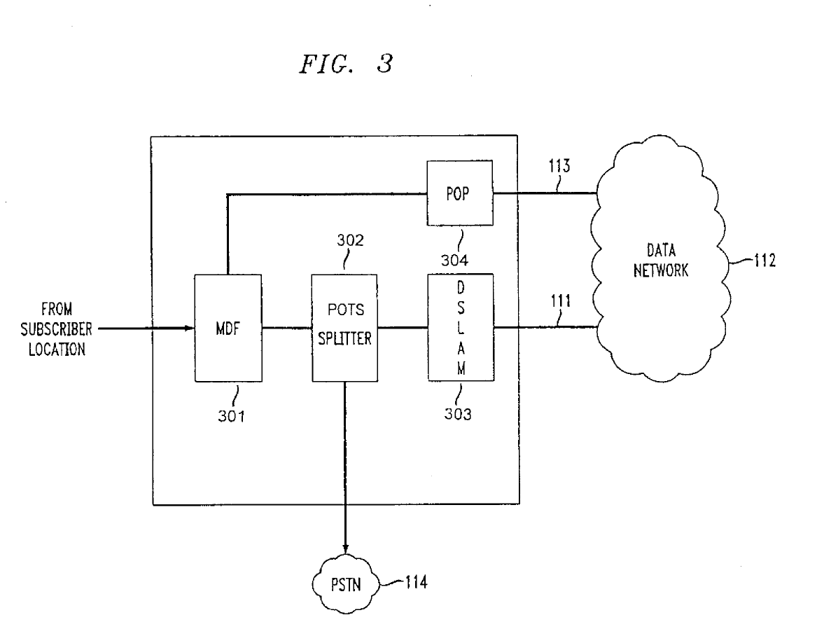

FIG. 3 shows a more detailed view of a serving central office.

In particular, an MDF 301, POTS splitter 302, complementary DSL device 303, and analog dial point of presence (“POP”) 304 is shown.

The MDF 301 aggregates incoming service lines and routes traffic to appropriate locations. Analog dial-up session traffic from the analog modem module 204 is routed to the analog dial POP 304. Analog voice traffic from the telephone 105 is routed to the POTS splitter 302 and to the PSTN 114. DSL data traffic from the DSL modem module 205 is also routed to the POTS splitter 302 but directed to the data network 112.

The POTS splitter 302 acts as a corresponding device for the splitter 106 located at the subscriber's location 101. The POTS splitter 302 and splitter 106 are devices known by those of ordinary skill in the art which operate in conjunction to allow for simultaneous DSL and analog voice channel transmission over the service line 109.

Although splitters are disclosed, other DSL technologies which allow for simultaneous DSL and analog voice channel transmission over the same service line may be implemented within the principles of the present invention.

The complementary DSL device 303 serves as a corresponding modem device to the DSL modem module 205 which connects to the data network 112 via a high speed connection 111. The complementary DSL device 303 is preferably a DSL access multiplexer (“DSLAM”) as known by those of ordinary skill in the art.

The analog dial POP 304 serves as a corresponding modem device to the analog modem module 204 which also connects to the data network 112 via a high speed connection 113. The analog dial POP 304 preferably supports up to 56 kbps as known by those of ordinary skill in the art.

High speed connections 111 and 113 preferably support at least T1 speeds (i.e. 1.5 Mbps) or higher as known by those of ordinary skill in the art.

Although a 56 kbps analog dial POP is shown, other analog dial POPs which use an analog voice channel may be implemented within the principles of the present invention.

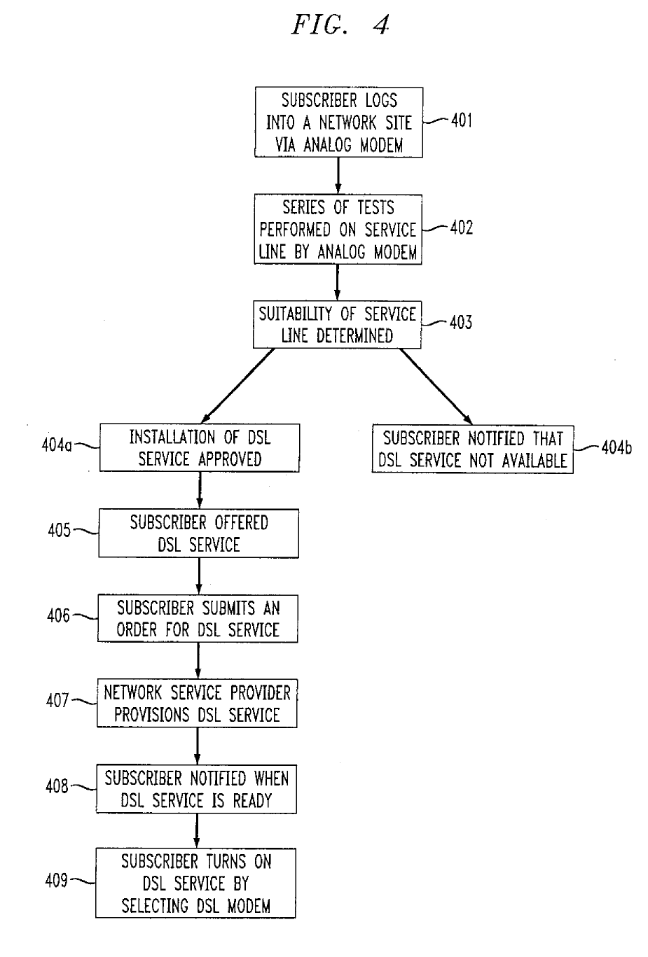

FIG. 4 shows an exemplary process of deploying DSL in accordance with the principles of the present invention.

In particular, in step 401 a subscriber via the analog portion of a combination analog/DSL modem logs into a network site to request DSL service.

Preferably, the subscriber may log into a network site 113 by inserting a computer program product 102 (e.g. a diskette or CD) to initiate an analog dial-up session via the analog modem module 204 of the combination analog/DSL modem 104. The subscriber may receive the computer program product 102 via a directed mailing or by any wide variety of means.

Preferably, upon logging into the network site 113, the user is prompted to provide certain information such as address, and phone number. However, other information may be requested from the user in accordance with the principles of the present invention.

In step 402, a series of parameter tests is performed by the combination analog/DSL modem 104. As noted above, these parameter tests are handled automatically without the need for manual intervention by the combination analog/DSL modem 104 using algorithms and DSP code known by those of ordinary skill in the art to measure several parameters.

These measured parameters are then passed automatically to the network service provider operating the network site 113.

In step 403, a suitability for supporting DSL services is automatically determined by the network service provider based on an analysis of the parameters measured by the combination DSL/analog modem 104.

The parameters measured by the combination DSL/analog modem 104 may be automatically compared without manual intervention to the technical requirements of DSL, although manual assistance may be provided within the scope of the present invention. The resulting suitability determined is then passed automatically to the network service provider.

In step 404b, if the measured parameters are not within technical limits, then the subscriber is notified that DSL service is not available. The notification may also include the reason why DSL service is not available (e.g. distance too far, bridge tap detected, etc.).

Notification may be delivered to the subscriber by a wide variety of ways such as email, or written notification. Preferably, the subscriber is notified via email within 24 hours.

Although, email or written notification is disclosed, other types of notification which allow for quick delivery, e.g., within 24 hours may be used in accordance with the principles of the present invention.

In step 404a, if the measured parameters are within technical limits, the subscriber is informed that DSL service is available. In step 405, the network service provider may then substantially immediately offer DSL service to that subscriber, without requiring the dispatch of any personnel (and potentially without the expenditure of any man-hours). A subscriber may be informed by a wide variety of means such as email, or written notification. Preferably, the subscriber is immediately informed via email.

In step 406, a subscriber responds positively to the offer of DSL service and submits an order. A subscriber may submit an order by replying to a notification email, filling out a written notification sent to the subscriber, or calling the network service provider. Preferably, the subscriber submits an order via email.

In step 407, the network service provider responds to the subscriber's order by provisioning a connection between the subscriber's location 101 and the network service provider's complementary DSL device 303, and updates service turn-on and billing information. Preferably, this would occur, e.g., within 24 hours.

In step 408, the network service provider informs the subscriber that DSL service has been turned on. Notification may be by a wide variety of means such as email or written notification. Preferably, the subscriber is notified via a suitably fast and automatic mechanism, e.g., email perhaps in conjunction with a written notification by regular mail.

In step 409, the subscriber turns on DSL service by selecting the DSL portion of the combination analog/DSL modem 104, and substantially immediately gains access to network resources.

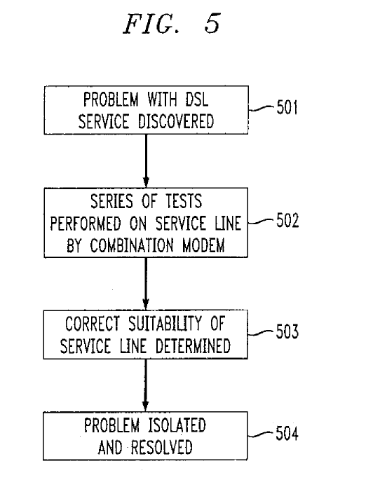

FIG. 5 shows how post installation issues such as troubleshooting may be handled as part of automatic deployment of DSL service, in accordance with the principles of the present invention.

In particular, in step 501, the subscriber discovers a problem with his/her DSL service, and accordingly notifies the network service provider. A problem may be noted at any time, and by any of a wide variety of symptoms, such as slow performance, error messages, etc.

Notification to the network service provider may be by any of a wide variety of means such as email, or phone call. Preferably, the network service provider is notified via a suitably fast mechanism, e.g., via email.

In step 502, the network service provider may respond to the problem report by the subscriber. In order to troubleshoot the DSL service, the subscriber or network service provider may remotely and automatically direct the combination analog/DSL modem 104 into a test mode.

In step 503, the network site 113 is logged into for troubleshooting, and the combination analog/DSL modem 104 initiates any one of a series of tests via the analog modem module 204 or DSL modem module 205 to determine the current suitability of the service line. These troubleshooting tests are preferably handled automatically without manual effort. The results of these troubleshooting tests may then be passed automatically to the network service provider for analysis.

In step 504, the network service provider may analyze the remotely received information and appropriately isolate and potentially resolve the problem without ever having dispatched a repair crew to the subscriber's premises. Diagnosis may be performed by a wide variety of ways without manual effort.

Ideally, within 24 hours the service turn-on and billing information are updated and the subscriber is notified by the network service provider. In response, the DSL modem module 205 of the combination analog/DSL modem 104 would be selected and a subscriber would immediately have broadband access to the desired network resources.

Also, since the combination DSL/analog modem 104 is located at the actual location, i.e., 101, where DSL service is delivered, troubleshooting and testing can be initiated at any time by the subscriber or network service provider.

Thus, the present invention provides a method for automating and improving the process of deploying DSL.

Accordingly the deployment of DSL service is improved and made more efficient by reducing the manual effort and other inefficiencies required for the implementation of DSL services over a telephone line.

While the invention has been described with reference to exemplary embodiments thereof, those skilled in the art will be able to make various modifications to the described embodiments of the invention without departing from the true spirit and scope of the invention.

What is claimed is:

1. A combination analog/DSL modem (e.g., 104), comprising:
a DSL modem module (e.g., 205) supporting DSL modem communications with a serving central office; and
an analog modem module (e.g., 204) supporting analog modem communications with the serving central office, wherein the combination analog/DSL modem:
(a) transmits, prior to provisioning of DSL service for the combination analog/DSL modem and via the analog modem module, a request for DSL service for the combination analog/DSL modem;
(b) performs one or more tests related to suitability of the combination analog/DSL modem for the DSL service to generate test results;
(c) transmits, via the analog modem module, the test results;
(d) receives, after transmitting the test results and via the analog modem module, notice that the DSL service has been provisioned; and
(e) selects, after receiving the notice, the DSL modem module for communications using the provisioned DSL service.

2. The invention of claim 1, wherein the request for DSL service is transmitted via the serving central office to a data network site (e.g., 313).

3. The invention of claim 1, wherein, after the combination analog/DSL modem transmits the test results, the combination analog/DSL modem:
(d1) receives, via the analog modem module, an offer for the DSL service;
(d2) transmits, after receiving the offer and via the analog modem module, an order for the DSL service; and
(d3) receives, after transmitting the order and via the analog modem module, the notice that the DSL service has been provisioned.

4. A method for a combination analog/DSL modem (e.g., 104) having (i) a DSL modem module (e.g., 205) supporting DSL modem communications with a serving central office and (ii) an analog modem module (e.g., 204) supporting analog modem communications with the serving central office, wherein the method comprises:
(a) transmitting, prior to provisioning of DSL service for the combination analog/DSL modem and via the analog modem module, a request for DSL service for the combination analog/DSL modem;
(b) performing one or more tests related to suitability of the combination analog/DSL modem for the DSL service to generate test results;
(c) transmitting, via the analog modem module, the test results;
(d) receiving, after transmitting the test results and via the analog modem module, notice that the DSL service has been provisioned; and
(e) selecting, after receiving the notice, the DSL modem module for communications using the provisioned DSL service.

5. A method for a network service provider to provision DSL service for a combination analog/DSL modem having (i) a DSL modem module (e.g., 205) supporting DSL modem communications with a serving central office and (ii) an analog modem module (e.g., 204) supporting analog modem communications with the serving central office, wherein the method comprises:
(a) receiving, prior to provisioning of DSL service for the combination analog/DSL modem and via the analog modem module, a request for DSL service for the combination analog/DSL modem;
(b) receiving, via the analog modem module, test results corresponding to one or more tests performed by the combination analog/DSL modem related to suitability of the combination analog/DSL modem for the DSL service;
(c) determining that the combination analog/DSL modem is suitable for the DSL service based on the received test results;
(d) provisioning, after determining that the combination analog/DSL modem is suitable for the DSL service, the DSL service;
(e) transmitting, after provisioning the DSL service and via the analog modem module, notice that the DSL service has been provisioned; and
(f) supporting communications by the combination analog/DSL modem using the provisioned DSL service.
